(19) United States
(12) Patent Application Publication
(10) Pub. No.: US 2010/0115729 A1
(43) Pub. Date: May 13, 2010

(54) CONCEALED DOOR HINGE

(76) Inventor: Hubert NEUKOETTER, Beelen (DE)

Correspondence Address: K.F. ROSS P.C., 5683 RIVERDALE AVENUE, SUITE 203 BOX 900, BRONX, NY, 10471-0900, US

(21) Appl. No.: 12/611,314

(22) Filed: Nov. 3, 2009

(30) Foreign Application Priority Data
Nov. 7, 2008 (DE) 102008056327.7

(51) Int. Cl. E05D 7/04; E05D 7/00; A47B 96/06

(52) U.S. Cl. 16/235; 16/379; 248/201

(57) ABSTRACT

A concealed door hinge for installation between a door edge and a door frame has two leaf assemblies that can be recessed in the door frame and in the door edge. Each assembly has a pair of longitudinally spaced housing ends each formed with a throughgoing screw-mounting hole for securing the housing end to the edge or frame and a hollow middle part extending longitudinally between and fixed to the housing ends. A swivel mechanism has at least two parts that interconnect the leaf assemblies.

### FIELD OF THE INVENTION

The present invention relates to a hinge. More particularly this invention concerns a concealed door hinge.

### BACKGROUND OF THE INVENTION

A typical concealed door hinge has two leaf assemblies that can be recessed in a door frame and in the edge of a door panel. Moreover, the door hinge comprises a two-part swivel mechanism that interconnects the leaf assemblies.

Such a concealed door hinge is described, for example, in U.S. Pat. No. 6,829,808. Here the two elongated leaf assemblies are connected to one another in a freely rotatable manner via the swivel mechanism. One of the leaf assemblies is set in a mortise of the door frame and the other leaf assembly in the edge of a door panel. For easier assembly it has proven useful in practice to equip door hinges of this type with adjusters so that the door panel can be shifted relative to the door frame. The adjustability can optionally be possible in one direction or in several directions independent of one another.

With a door hinge that is equipped with one or more adjusters, for example, inserts are provided in one or in both leaf assemblies. With respect to manufacture, this means that a leaf assembly of a door hinge without adjusters differs structurally from a leaf assembly of a door hinge with adjusters. Similarly, the leaf assemblies can also differ with respect to their dimensions. Thus, for example, a leaf assembly to which a swivel mechanism for transferring large loads is to be attached and that furthermore has several adjusters requires considerably more space within the frame or within the door panel than a leaf assembly that does not have any adjusters and to which a less robust swivel mechanism is attached.

### OBJECTS OF THE INVENTION

It is therefore an object of the present invention to is provide an improved concealed door hinge.

Another object is the provision of such an improved concealed door hinge that overcomes the above-given disadvantages, in particular that is of simple design so that it can be manufactured more cost-effectively.

### SUMMARY OF THE INVENTION

A concealed door hinge for installation between a door edge and a door frame has according to the invention two leaf assemblies that can be recessed in the door frame and in the door edge. Each assembly has a pair of longitudinally spaced housing ends each formed with a throughgoing screw-mounting hole for securing the housing end to the edge or frame and a hollow middle part extending longitudinally between and fixed to the housing ends. A swivel mechanism has at least two parts that interconnect the leaf assemblies and are supported on the housing ends.

The modular construction of the leaf assemblies provides the advantage that, for example, two door hinges that differ with respect to the height of their swivel mechanisms can be equipped with the same ends. Only connecting housing middles with different heights need to be provided, which are set to the length of the respective swivel mechanism. Accordingly, it is not necessary to construct a special leaf assembly for each type of door hinge.

The connecting housing middle that connects the two ends to one another is advantageously basically of U-section. A U-section design is preferred in particular since the mortises into which the leaf assemblies are placed are to be completely or at least largely concealed for appearance's sake. Alternately thereto, however, in principle a connecting housing middle can also be provided that is formed from two side plates or a simple back plate. The housing ends can be attached to the connecting housing middle without restriction by screws, rivets or a slip swivel mechanism. Thus, for example, with the preferred U-shaped design, openings can be provided on the side faces and/or on the back face of the connecting housing middle, into which dimples of the housing ends or other attachment means engage for a force-fit connection.

Regardless of the design of the connecting housing middle, its function is to attach the two ends of a leaf assembly to one another for the purpose of mounting in the mortise of a frame or of a door panel. Since the housing ends with their mounting plates are securely screwed inside the frame and inside the wing, the connecting housing middle does not have a load-bearing function.

With a preferred embodiment of the door hinge according to the invention that the housing ends are made from cast metal. With respect to manufacture where comparatively complex cast parts are used, since only the housing ends are to be produced as cast parts according to the invention, a potential for cost saving results for the manufacture of door hinges of different designs in large production runs. Through the modular concept of the leaf assemblies of the door hinge it is now no longer necessary to produce and provide leaf assemblies for different measurements and different shapes necessary. It is necessary only to produce and provide connecting housing middles of different heights with which then, in combination with the housing ends, leaf assemblies of the desired design are to be formed. It can thereby also be provided, for example, that the connecting housing middle is made from sheet steel. Sheet steel has the advantage that it is easy to process so that a further reduction in costs can be achieved. Adequate strength of the entire door hinge leaf assembly can be achieved even with thin sheet steel. This is in addition to the fact that the forces and moments that are transferred from the door panel via the door hinge to the frame are essentially transferred through the housing ends attached to the door frame and the door panel and the swivel mechanism attached thereto. For this reason, the connecting housing middle can also be made of plastic, for example.

Advantageously, the connecting housing middle is force-fitted to the ends of a leaf assembly. Preferably, the force fit can be formed by punching or a comparable local material deformation. To this end, the housing ends can have an indentation in the form of a groove, for example. The force-fit connection has the advantage that it can be produced particularly easily in the manufacture of the door hinge and that no further attachment elements are necessary. Alternatively or in additional to the force-fit connection, a screwed connection can also be provided, the connecting housing middle being secured by screws to the housing ends of a leaf assembly. The modularly assembled leaf assembly is made very strong when held together by screws. This stability can be desirable in the assembly of big leaf assemblies. Alternatively to the screwed connection or to the force-fit connection, other connections, such as, e.g. rivets or bent locating lugs are also conceivable. Furthermore, connections by material can also be advantageous. Thus, for example, the housing ends can be attached to one another via the connecting housing middle by welded joints.

With respect to a further reduction in the manufacture costs, it can be useful for at least one of the leaf assemblies to have two identical ends. In particular with cast parts, where a corresponding casting mold is used for manufacture, it is advantageous if different molds do not have to be used for the two ends of a leaf assembly. Accordingly, with the manufacture of a leaf assembly only one small mold for producing the housing ends is necessary. Two identical ends of this type together with the connecting housing middle then form the leaf assembly.

In a preferred embodiment of the door hinge according to the invention the housing ends have respective attachment tabs for mounting in a mortise. Preferably, the housing ends each comprise a support part and an insert, the swivel mechanism being held in the insert. A multipart embodiment of a housing end of this type renders possible the provision of adjusters for the adjustment of the door panel in the frame.

With respect to vertical adjustment of the door panel, for example, an adjuster for adjusting the door panel vertically is provided in a housing end, the vertical direction being parallel to the longitudinal direction of the leaf assembly. This adjustment can be realized, for example, in that the support part of the housing end is slidable relative to the tab. This type of sliding action can be achieved in that the tab has vertically aligned longitudinal slots that are engaged by screws provided in the support part. If the tab, for example, has already been fixed inside the mortise of a frame, the support can be displaced relative to the tab vertically by loosening the screws that engage the elongated slots, the swivel mechanism of the door hinge and thus also the door panel being attached to the support. Alternatively thereto or in addition thereto, an adjustment screw acting on a wedge is provided in the housing end, the wedge being aligned at right angles to the adjustment screw and vertically. The wedge thereby bears against the support of the housing end such that the support can be positioned vertically by actuation of the adjustment screw.

In a further embodiment of the door hinge according to the invention, an adjuster for adjusting the door panel in a first horizontal direction (X) is provided in a housing end. This first horizontal direction (X) thus runs orthogonally to the front face of the respective leaf assembly. With an adjuster of this type the lateral clearance of the door panel inside the door frame can be adjusted after mounting of the door. Adjustment of the door panel in the first horizontal direction can be done, for example, by a threaded element with which the insert is held in a support. Adjustment of the threaded element moves the insert relative to the support in the first horizontal direction (X) so that the side-to-side position of the door panel, which is connected to the insert in the support via the swivel mechanism, can be changed.

A further embodiment of the door hinge according to the invention provides that an adjuster for adjusting the door panel in a second horizontal direction (Y) is provided in a housing end. This second horizontal direction (Y) thus runs parallel to the front face of the respective leaf assembly. An adjuster of this type can be realized, for example, in that the insert of a housing end has horizontally aligned longitudinal slots that are engaged by at least one screw that can be attached in the support of the housing end. Alternatively thereto, an eccentric can also be provided that relatively displaces the insert and the support. Actuation of this eccentric shifts the insert relative to the support in the second horizontal direction. Alignment of the door panel in the frame can be effected by adjustment of the door panel in the second horizontal direction (Y).

In a particularly preferred embodiment of the door hinge according to the invention it is advantageous that an adjuster for adjusting the door panel vertically (Z) is provided in the housing ends of one of the leaf assemblies. At the same time, an adjuster for adjusting the door panel in a first horizontal direction (X) and/or an adjuster for adjusting the door panel in a second horizontal direction (Y) are provided in the housing ends of the other leaf assembly. The vertical direction (Z) is parallel to the longitudinal direction of the leaf assembly. The second horizontal direction (Y) is orthogonal to the first horizontal direction (X).

This embodiment of the door hinge makes it possible to adjust the door panel in two or all three directions in space relative to the door frame. The adjuster can be embodied as described above. By providing the adjusters for the horizontal directions inside one of the leaf assemblies, adjustment of the door panel after its insertion in the door frame is advantageous because of the operation of the adjusters. Providing the arrangement of the adjusters in one leaf assembly ensures that the two adjustment axes (X, y) continue to run orthogonally to one another, even with an opening angle of the inserted but not yet adjusted door of, for example, approximately 90°. This would not be the case if the adjuster for the first horizontal direction is provided in the one leaf assembly and the adjuster for the second horizontal direction in the other leaf assembly. With the arrangement of the adjuster for the horizontal adjustment in one leaf assembly, the installer can thus adjust the one horizontal direction independently of the other horizontal direction and thus adjust the door more easily. Preferably, the installer will insert the door hinge such that the adjusters are provided in the leaf assembly that is mounted in the door panel.

With a particularly preferred embodiment of the door hinge according to the invention the swivel mechanism has two brackets that are connected to one another by a common rotation axis in a freely rotatable manner. Each bracket is thus pivoted on its one side in the inserts and on its other side slidably supported in sliding guides of the inserts. Alternatively thereto, it can also be provided that one of the two brackets is pivoted on both sides and the other bracket is slidably supported in sliding guides of the inserts. It can also be provided that the swivel mechanism has at least two multipart brackets that are rotatably connected to one another in a scissor-like manner and supported in the housing middle on at least two rotation axes.

With respect to the optical design of the door hinge, it can be advantageous that at least one cover is releasably mounted on a housing end so holes for mounting screws can be covered. A cover of this type can be adapted in color to the design of the door frame, for example, the concealed door hinge being provided unobtrusively in the frame even when the door is open. If the door frame and the door panel have a different design in terms of color, it can be useful for the housing ends in the door frame to be provided with different covers from those ends that are provided in the door panel.

### BRIEF DESCRIPTION OF THE DRAWING

The above and other objects, features, and advantages will become more readily apparent from the following description, reference being made to the accompanying drawing in which:

FIG. 1 is a side view of a door hinge in the opened position;

FIG. 2 is a side view of a door hinge leaf assembly taken in the direction of arrow II of FIG. 1;

FIG. 3 is a horizontal section along line through the door hinge according to FIG. 1; and

FIG. 4 is a vertical section through an end of a leaf assembly.

### SPECIFIC DESCRIPTION

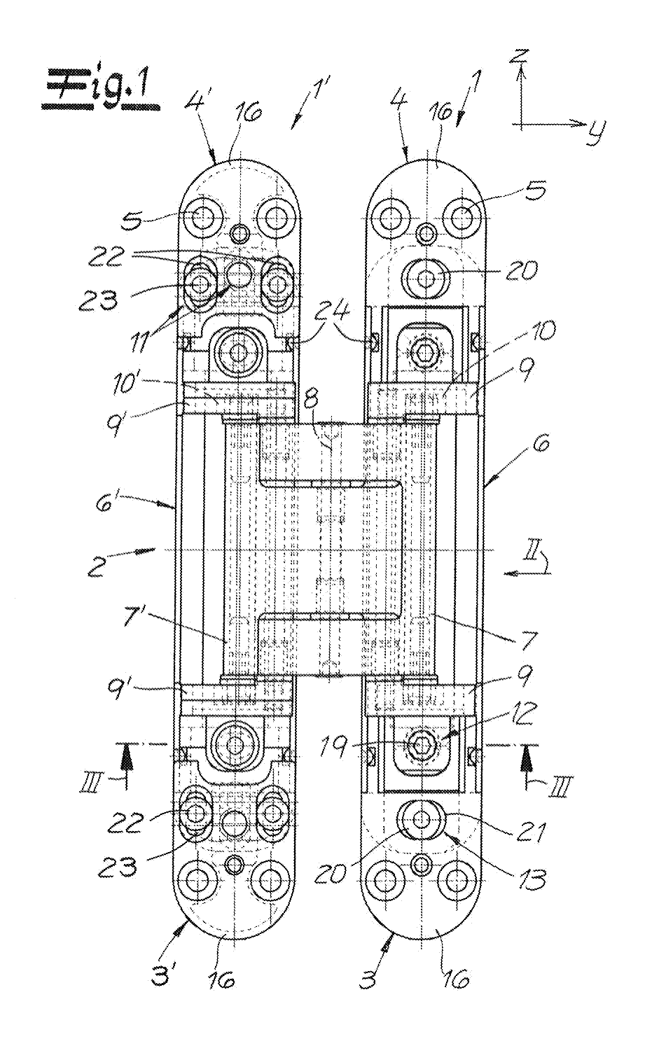

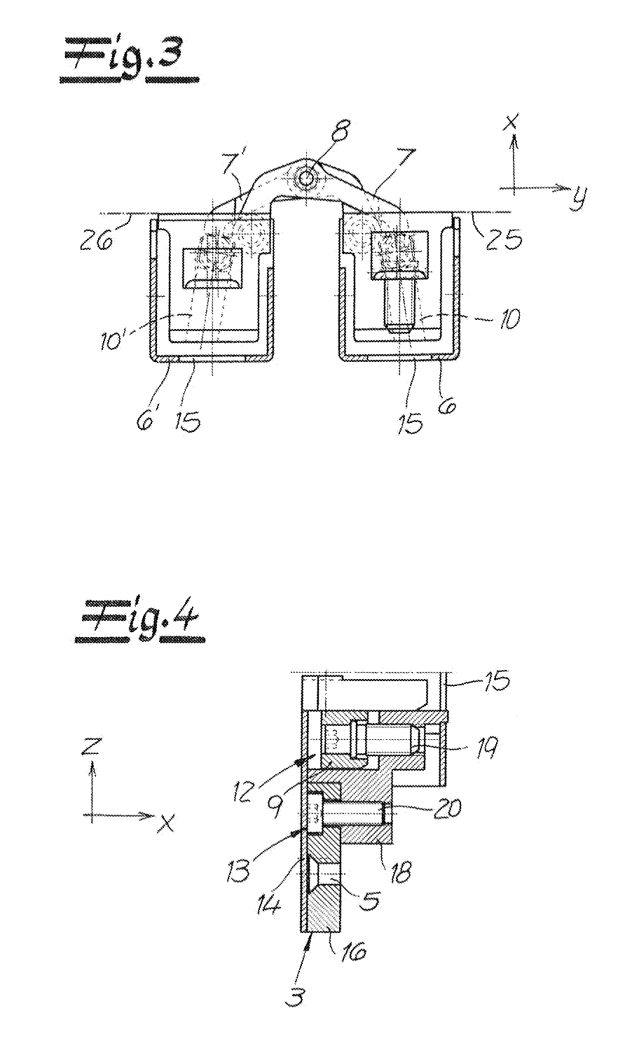

As seen in FIG. 1 a door hinge for concealed installation between a door panel shown schematically in FIG. 3 at 25 and a door frame 26 includes two leaf assemblies 1 and 1′ that can be mortised into the door frame and into the edge of the door panel. The leaf assemblies 1 and 1′ are connected to one another by a swivel mechanism 2 having at least two parts. The leaf assemblies 1 and 1′ each have two ends 3, 3′ and 4, 4′ each formed with holes 5 for unillustrated mounting screws. The swivel mechanism 2 is supported on the housing ends 3, 3′ and 4, 4′. Respective connecting housing middles 6, 6′ are provided between the housing ends 3, 3′ and 4, 4′ and each connect the respective two ends 3, 3′ and 4, 4′ to one another. The housing ends 3, 3′ and 4, 4′ can be made, for example, from cast metal.

FIG. 1 shows that the swivel mechanism 2 has two generally U-shaped brackets 7 and 7′ (see above-cited U.S. Pat. No. 6,829,808) pivotally connected to each other at their overlapping center bights at a normally vertical center pivot axis 8. Each brackets 7 and 7′ is pivoted about a respective vertical outer axis on its one end in a respective one of the inserts 9 and 9′ and its other end can slide in a respective guide 10 or 10′ in the other of the inserts 9 and 9′ in a direction generally perpendicular to the view plane of FIG. 1 (see FIG. 3). The inserts 9 and 9′ are carried by the housing ends 3, 3′ and 4, 4′.

Furthermore, adjusters 11, 12, and 13 for setting the position of the door panel inside the frame can be provided in the housing ends 3, 3′ and 4, 4′ of both leaf assemblies 1 and 1′. FIG. 1 further shows that the adjusters 11 for the door panel in a vertical direction z are provided in the housing ends 3′ and 4′ of the one leaf assembly 1′. Furthermore, the adjusters 12 for adjusting the door panel in a first horizontal in/out direction x and an adjuster 13 for adjusting the door panel in a second side/side horizontal direction y are provided in the housing ends 3 and 4 of the other leaf assembly 1. The vertical direction z extends parallel to the longitudinal direction of the leaf assembly 1. The first horizontal in/out direction x runs orthogonally to the face of the respective leaf assembly 1. The second horizontal side/side direction y runs orthogonally to the first horizontal direction x and to the vertical direction z. Due to the modular concept of the door hinge according to the invention, alternatively to the embodiment shown in FIG. 1, any other combination of the adjusters 11, 12, 13 inside the leaf assemblies 1 and 1′ can be provided by replacement or exchange of the housing ends 3, 3′ and 4, 4′. In other words all three sets of adjusters 11, 12, and 13 could be provided in one or both leaf assemblies 1 and 1′, or they could be distributed as mechanics require between the two leaf assemblies 1 and 1′.

If required, the door hinge can also be produced without an of the adjusters 11, 12, or 13. It can have an adjuster for movement in one direction or in two directions independent of one another. In the example shown in FIG. 1, the door hinge has the adjusters 11, 12, 13 for adjusting the door panel in all three directions z, x, y independently of one another.

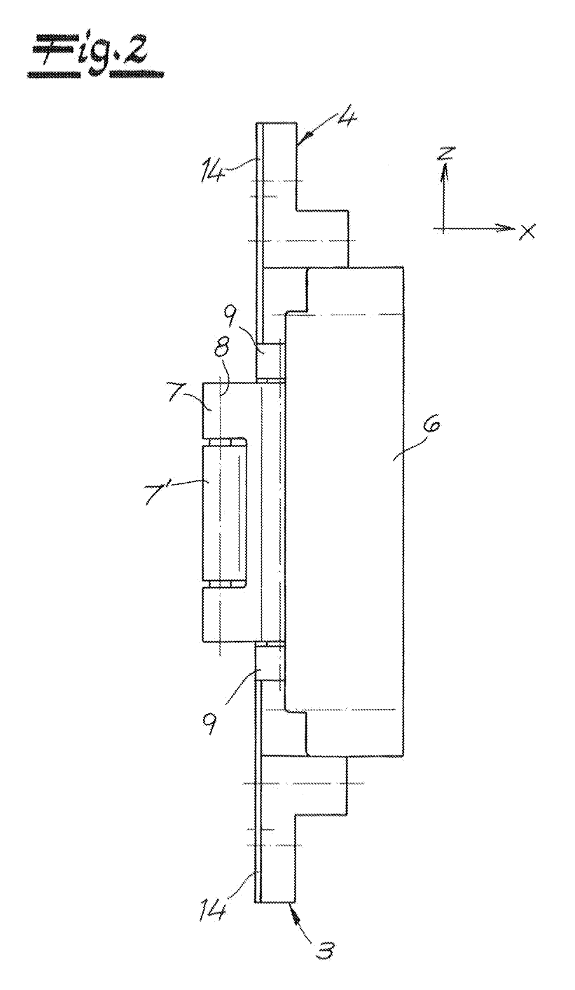

A side view of a leaf assembly of a door hinge according to FIG. 1 is shown in FIG. 2. The connecting housing middle 6 or 6′ between the housing ends 3, 3′ or 4, 4′ is force-fitted in position as indicated in FIG. 1 at pressed-in dimples 24. The housing ends 3, 3′ and 4, 4′ on the ends of the respective leaf assemblies 1 and 1′ are identical. A cover plate 14 shown in FIGS. 2 and 4 but not in FIG. 1 can be attached to and removed from each end 3, 3′ and 4, 4′. The holes 5 for the mounting screws can thus be covered as well as any of the adjusters 11, 12, or 13.

FIG. 3 shows that the connecting housing middles 6 and 6′, which can be made, for example, from sheet steel, are essentially U-shaped. They furthermore are formed in their back walls with cutouts 15 so as to be able to accurately fit and secure the connecting housing middles 6 and 6′ between the respective ends 3, 3′ and 4, 4′.

FIG. 4 shows that the housing ends 3, 3′ and 4, 4′ of the leaf assemblies 1 and 1′ each have an attachment tab 16 for anchoring in a mortise. The holes 5 are provided in the tab 16 with which the tab 16 can be attached in a mortise of a door frame or of a door panel. The drawing also shows that the housing ends 3, 3′ and 4, 4′ of a leaf assembly 1 and 1′ each is have a support part 18 for the respective insert 9 or 9′. The swivel mechanism 2 is supported in the inserts 9 and 9′. Each insert 9 and 9′ can, as will be described below, move in the directions x, y, and z in the supports 18 of the respective ends 3, 3′, 4, and 4′.

FIG. 4 further shows that the adjusters 12 for the door panel in the first horizontal direction x is provided in the housing ends 3 and 4. This first horizontal direction x thus runs orthogonally to the face of a leaf assembly 1 in the closed position of the door panel. According to FIG. 4, each adjuster 12 for in the first horizontal in/out direction x is formed by a threaded element 19 that is freely rotatable in but coupled for movement in the direction x with the insert 9 and is threaded into the support part 18. When the screw 19 is rotated in one direction, the insert 9 is moved in the direction x into the respective mortise, and when oppositely rotated, it moves horizontally oppositely in the direction x.

Similarly, the adjusters 13 for the second horizontal direction y are provided in the housing ends 3 and 4. The second horizontal side/side direction y runs parallel to the front face of the leaf assembly 1 in the closed position of the door leaf. According to FIG. 4, this adjuster 13 for the second horizontal direction y has a screw 20 that engages through a longitudinal slot 21 in the tab 16 and is threaded into the support part 18. When the screw 20 is loosened, the part 18 of the insert 9 can be shifted horizontally in the direction y tab 16 that is screwed to the door edge or door frame.

The adjuster 11 for vertical direction z similarly comprises vertical slots 22 (FIG. 1) in the tabs 16 of the ends 3′ and 4′ and screws 23 like the screws 20 engaged through them and into the respective support parts 18 so that when the screws 23 are loosened, the parts 18 and with them the entire insert 9′ can be vertically adjusted. Thus here the vertical (direction z) adjusters 11 are provided on the leaf assembly 1′ and the horizontal in/out (direction x) adjuster 12 and horizontal side/side (direction y) adjuster 13 are provided on the leaf assembly 1. In other words, the insert 9 of the leaf 1 can be shifted in directions y and z relative to the respective ends 3 and 4 while the insert 9′ can be adjusted in direction z relative to the ends 3′ and 4′

I claim:

1. A concealed door hinge for installation between a door edge and a door frame, the hinge comprising:
two leaf assemblies that can be recessed in the door frame and in the door edge, each assembly having
a pair of longitudinally spaced housing ends each formed with a throughgoing screw-mounting hole for securing the housing end to the edge or frame and
a hollow middle part extending longitudinally between and fixed to the housing ends; and
a swivel mechanism having at least two parts that are supported on the housing ends and interconnect the leaf assemblies.

2. The door hinge defined in claim 1 wherein the connecting housing middle is of U-section.

3. The door hinge defined in claim 1 wherein the housing ends are of cast metal.

4. The door hinge defined in claim 3 wherein the housing middle is of sheet steel.

5. The door hinge defined in claim 4 wherein the housing middle is force-fitted to the housing ends.

6. The door hinge defined in claim 1 wherein the housing ends of at least one of the leaf assemblies are identical.

7. The door hinge defined in claim 1 wherein each housing end has an attachment tab adapted to fit in a mortise of the respective edge or frame and formed with the respective screw hole.

8. The door hinge defined in claim 1, further comprising
respective support parts each carried on a respective one of the ends, and
respective inserts in each leaf assembly each carried on the respective support parts, the swivel mechanism being pivoted and guide only on the inserts.

9. The door hinge defined in claim 8, further comprising:
adjusting means for shifting at least one of the inserts longitudinally relative to the respective support parts.

10. The door hinge defined in claim 9, further comprising:
adjusting means for shifting at least one of the inserts transversely in a side/side direction relative to the respective support parts.

11. The door hinge defined in claim 10, further comprising:
adjusting means for shifting at least one of the inserts transversely in an in/out direction transverse to the side/side direction relative to the respective support parts.

12. The door hinge defined in claim 11 wherein the adjusting means for the side/side direction are provided on one of the leaf assemblies and the adjusting means for the in/out direction are provided on the other of the leaf assemblies.

13. The door hinge defined in claim 12 wherein the side/side direction is parallel to a face of the one leaf assembly and the in/out direction is perpendicular to a face of the other leaf assembly.

14. The door hinge defined in claim 11, further comprising
a respective removable cover plate overlying the end parts and housing middle of each leaf assembly and covering the respective adjusting means and the screw holes.

15. The door hinge defined in claim 8 wherein the swivel mechanism includes two brackets centrally pivoted on each other and each having two outer ends one of which is pivoted in a respective one of the inserts and the other of which is slidable in the other of the inserts.
